(19) United States
(12) Patent Application Publication
(10) Pub. No.: US 2023/0188619 A1
(43) Pub. Date: Jun. 15, 2023

(54) METHODS AND SYSTEMS FOR EVENT MANAGEMENT

(71) Applicant: HUAWEI CLOUD COMPUTING TECHNOLOGIES CO., LTD., Gui Zhou Province (CN)

(72) Inventors: Eugene CHAN, Richmond Hill (CA); JinRong LUO, Markham (CA); Yu ZHAO, Richmond Hill (CA)

(73) Assignee: HUAWEI CLOUD COMPUTING TECHNOLOGIES CO., LTD., Gui Zhou Province (CN)

(21) Appl. No.: 17/546,885

(22) Filed: Dec. 9, 2021

(51) Int. Cl. H04L 67/55; H04L 67/562; H04L 67/564; H04L 67/567

(52) U.S. Cl. CPC H04L 67/26; H04L 67/2809; H04L 67/2819; H04L 67/2838

(57) ABSTRACT

A method for an index map-based event system includes receiving at least one subscription rule; processing the at least one subscription rule to determine an index map generation; generating an index map based on the determination; dynamically inserting into a received event, properties of the index map; and sending the modified event to a transport layer for dispatching. A method for dynamic property insertion in an event system includes receiving at least one subscription rule, each of the at least one subscription rule having a set of filter rules; generating an index map based on the filter rules; and annotating properties of a received event with properties referenced the index map correlating to characteristics of the received event. A device is configured to execute the methods disclosed herein. A system is configured to execute the methods disclosed herein.

### CROSS REFERENCE TO RELATED APPLICATIONS

This is the first application filed for the present disclosure.

### FIELD

The present disclosure pertains to the field of software architectures, and in particular to an event driven architecture (EDA).

### BACKGROUND

EDA is a modern cloud application design pattern that enables decoupled cloud services, applications and devices to detect and act on interested business or operational events when it happens.

An event orchestration system is a platform layer service that targets events distribution among decoupled applications, services and devices in an EDA-oriented solution. It enables governed and configurable event communication with flexibility, reliability and speed. An event orchestration system usually leverages a combination of event brokers as transport.

Event orchestration takes place asynchronously between publishing of events on event producers and processing of events on event consumers that are decoupled via the event orchestration platform.

To facilitate event orchestration in an efficient manner, filter configuration between orchestration endpoints is specified by event subscription owners. Event consumers can subscribe and react to multiple event types from various event sources at the same time, resulting in subscription rules being configured in the system.

In enterprise integration, event consumers may only be interested in a particular kind of event from an event source, which defines such a requirement in an event orchestration subscription rule. To support such a subscription requirement, event filtering from source events is part of the event framework runtime.

A subscription rule-based event service supports user-defined event orchestration rules, which configure asynchronous traffic flow of events by type between event source producers and event subscription consumers. However, the subscription rule-based event service model can result in large memory footprints, filtering implementation requirements and overall low event traffic efficiency.

Accordingly, there is a need for methods and systems to implement improved EDA-based event orchestration, that are not subject to one or more limitations of the prior art.

This background information is provided to reveal information believed by the applicant to be of possible relevance to the present disclosure. No admission is necessarily intended, nor should be construed, that any of the preceding information constitutes prior art against the present disclosure.

### SUMMARY

An object of embodiments of the present disclosure is to provide methods and systems for rule-based dynamic cloud event index and query.

An aspect of the disclosure provides for a method. The method includes receiving, by a system, at least one subscription rule. The method further includes processing, by the system, the at least one subscription rule. The method further includes generating, by the system, an index map based on the processing. The method further includes dynamically inserting, by the system, into a received event message, properties of the index map. The method further includes sending, by the event system, the modified event message.

In some embodiments the index map contains event correlated properties including at least one of: transport layer dispatch properties; and query process properties. In some embodiments properties of the index map are to be dynamically inserted into the received event message is determined by comparing the index map with a source type identifier of the received event message. In some embodiments the sending includes sending the modified event message to a transport layer for dispatching. In some embodiments the method further includes querying, by the system, the transport layer for event subscriptions based on subscription rules. In some embodiments the method further includes dispatching, by a dispatch service, the modified event message based on a result of the query. In some embodiments the at least one subscription rule includes at least one filter rule.

Another aspect of the disclosure provides for a method. The method includes receiving, by a system, at least one subscription rule, each of the at least one subscription rule having a set of filter rules. The method further includes generating, by the system, an index map based on the set of filter rules. The method further includes annotating, by the system, properties of a received event message with properties referenced in the index map correlating to characteristics of the received event message.

In some embodiments the characteristics include at least one of: an event generation system; an event generation application; and event generation service; an event consumption system; an event consumption application; and an event consumption service. In some embodiments the method further includes sending, by the system, the annotated event message to a transport layer for dispatching. In some embodiments the method further includes querying, by the system, the transport layer by event target subscription for subscription delivery.

Advantages of the embodiments disclosed herein include support for much more advanced, comprehensive and flexible event subscription rules in the enhanced event system where there is no limitation of event filter context specification. Further, the system disclosed by embodiments of the present disclosure removes the need of additional filtering implementation at consumer end components with no trade-off on performance from the conventional event system. Another advantageous aspect of the embodiments disclosed herein is that index map regeneration is dynamic and only necessary when source subscription has changed. A further advantage of the embodiments disclosed herein is that embodiments of the present disclosure result in highly improved event traffic efficiency, with low memory footprint in filer rules processing and query efficiency in event system by an index map modeling.

Another aspect of the disclosure provides for a computing device. The computing device includes a processor, and a non-transient computer readable memory having stored thereon machine executable instructions which when executed by the processor configure the device to execute the methods disclosed herein. For example, such a computing device is configured to receive at least one subscription rule; process the at least one subscription rule; generate an index map based on the processing, dynamically insert into a received event message, properties of the index map; and send the modified event message to a transport layer for dispatching.

Another aspect of the disclosure provides for a computing device. The computing device includes a processor, and a non-transient computer readable memory having stored thereon machine executable instructions which when executed by the processor configure the device to execute the methods disclosed herein. For example, such a computing device is configured to receive at least one subscription rule, each of the at least one subscription rule having a set of filter rules; generate an index map based on the filter rules; and annotate properties of a received event message with properties referenced the index map correlating to characteristics of the received event message.

A further aspect of the disclosure provides for a system. The system includes at least one processor and a memory storing instructions for execution by the at least one processor to implement: receive at least one subscription rule having a set of filter rules, generate an index map based on the set of filter rules, receive an event message, and annotate properties of the received event message with properties referenced the index map correlating to characteristics of the received event message.

In some embodiments the index map contains event correlated properties including at least one of: transport layer dispatch properties; and query process properties. In some embodiments which properties of the index map are to be dynamically inserted into the received event message is determined by comparing the index map with a source type identifier of the received event message. In some embodiments the memory further stores instructions for execution by the at least one processor to implement: query a transport layer for event subscriptions based on subscription rules. In some embodiments the memory further stores instruction for execution by the at least one processor to implement: dispatch the annotated event message based on a result of the query. In some embodiments the at least one subscription rule includes at least one filter rule. In some embodiments the characteristics include at least one of: an event generation system, an event generation application; and event generation service; an event consumption system; an event consumption application; and an event consumption service. In some embodiments the memory further stores instructions for execution by the at least one processor to implement: send the annotated event message to a transport layer for dispatching. In some embodiments the memory further stores instruction for execution by the at least one processor to implement: query the transport layer by event target subscription for subscription delivery.

Embodiments have been described above in conjunction with aspects of the present disclosure upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present disclosure will become apparent from the following detailed description, taken in combination with the appended drawings, in which:

FIG. 1 depicts publish/subscribe and routing systems, according to the prior art.

FIG. 2 illustrates an example event driven architecture, according to embodiments.

FIG. 3 illustrates an example method for an index map-based event system, according to embodiments.

FIG. 4 illustrates an example schematic of an event system using index map generation, according to embodiments.

FIG. 5 illustrates an example method for dynamic property insertion in an event system, according to embodiments.

FIG. 6 illustrates an example schematic of an event system using dynamic property insertion, according to embodiments.

FIG. 7 illustrates an example system for dynamic index map generation and index map based property annotation, according to embodiments.

FIG. 8 illustrates a block diagram of an example electronic device used for implementing methods disclosed herein, according to embodiments.

It will be noted that throughout the appended drawings, like features are identified by like reference numerals.

### DETAILED DESCRIPTION

Embodiments of the present disclosure describe event traffic control processing in an event orchestration system where, instead of event filtering by static batch matching process of subscription rule values, the event filtering is performed with dynamic rule-sensitive generated index map which facilitates event content-included and property-oriented queries in transport framework.

As used herein, “event” or “event trigger” shall be taken to mean an action or occurrence that is recognized by software. This may also be taken to mean a state of change in a computer subsystem, a change in a computing system at a particular time, or a set of conditions that create a change in a computing system. Further, as used herein an event and an event message shall be taken to have the same meaning. An event therefore may be a message emitted by a component when the state of the component is changed. The event may include the necessary data to evolve the older state to the newer one.

Existing cloud event system services are generally equipped with a filtering capability, yet it is not clear what indexing mechanism is implemented in these services. According to filter rule requirements, certain pattern matching requirements are ensured in their internal mechanisms. Further, at least one method of dynamic updating of an index exists in document base search indexing, however the method is not based on a dynamic nature in its query requirements, and is only applied in the field of property matching streaming event systems.

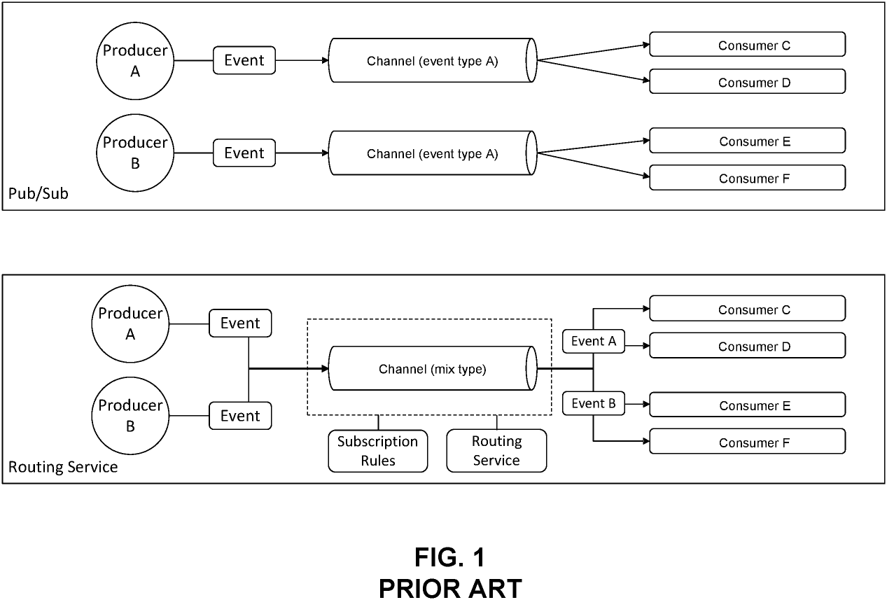

The dynamic index requirement nature of an event is unique to the subject event routing system where indices are dynamically based on subscription rules. A static event content index serves the requirement, yet it is not as efficient as embodiments of the present disclosure. FIG. 1 depicts pub/sub and routing service systems according to the prior art.

It is also important to note that common publish/subscribe (pub/sub) systems available on the market limit event filtering capability to be done by 1) event type sensitive channel separation between event producers and consumers, and 2) additional filtering logic implemented at consumer units. However, the subject routing system described in embodiments of the present disclosure is different, providing support for channel sharing among event of various schema types via low computation and memory requiring filtering capability by design. This results in no to low code requirements to fulfill the event filtering requirement.

Moreover, commercial event routing services are services with pub/sub modeling, where event separation and filter capabilities are performed with a channel separation mechanism and static event topic properties correlation between event sources, channel and targets. They do not support the topic-free and dynamic content based filter nature as part of the service as described in embodiments of the present disclosure.

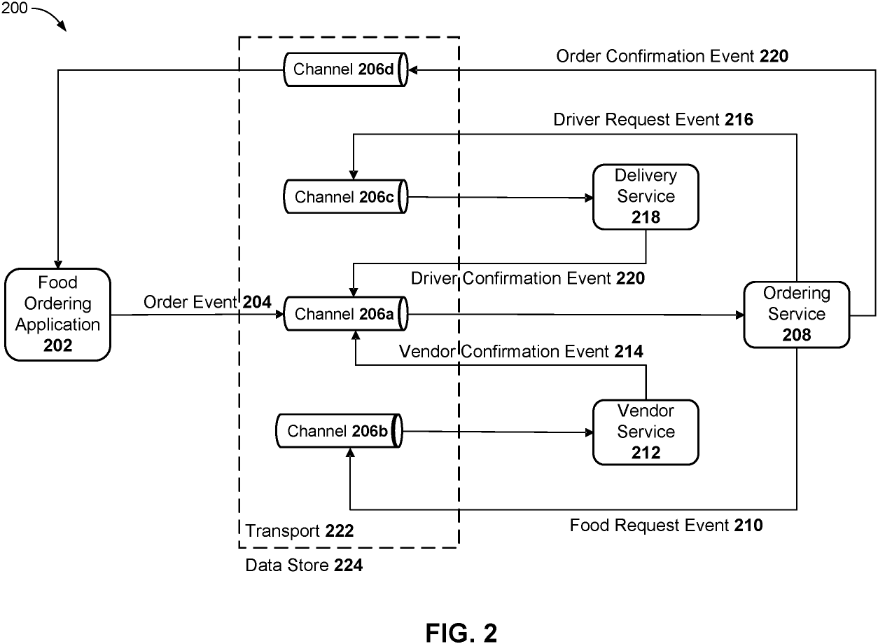

In contrast to FIG. 1, FIG. 2 depicts an example event driven architecture (EDA) system 200. For example purposes only, FIG. 2 describes a food ordering and delivery service in which a food ordering application 202 sends an order event 204 via a channel 206a to an ordering service 208. From the ordering service 208, a food request event 210 is sent to channel 206b, which forwards the request to a vendor service 212, for example a restaurant. The vendor service 212, if able to fulfil the request, sends a vendor confirmation event 214 back to channel 206a. The ordering service 208 also sends a driver request event 216 to channel 206c, which forwards the request to a delivery service 218. If the delivery service 218 is able to fulfil the request, it provides a driver confirmation event 220 back to channel 206a. With the necessary components of the food order confirmed, channel 206a can notify ordering service 208, which can then send an order confirmation event 220 to channel 206d. Channel 206d may then send a notification (not shown) back to the food ordering application 202 to confirm the order. Channels 206a to 206d are shown to exist in the transport layer 222 of a data store 224. While not shown, where services may be unable to fulfil a request, a corresponding event may still be sent in order to indicate that. Using the same example in FIG. 2, this could be, for example, a “vendor denial event” instead of a vendor confirmation event, or a “driver denial event” instead of a driver confirmation event. Such events may still be used in the system 200 to provide an overall confirmation or denial of the food order.

Embodiments of the present disclosure provide an enhancement to the basic event driven architecture of FIG. 2. In the event system disclosed in embodiments of the present disclosure, each event source type defined by subscription rules is associated with its own index map entry, where the index map entry is generated by rules aggregation of properties of source in same type at event subscription. The index map is then applied at property annotation time via transport layer dispatch upon source event arrival in the event system. Property-annotated events at transport layer are queried with rule based object value in the subsystem responsible for dispatching to consumers. In this context, dispatch refers to the distribution of events to targets, for example, event subscribers. In some embodiments, dispatch can include the distribution of modified event message to targets based on a result of the query.

In event systems where event filter engineering is done conventionally by matching of event content against subscription filter rule for event dispatching control, the filtering capacity of such system are limited by a set static property of event by event dispatching source with no consideration of its dynamic matching requirement in event routing use cases. Instead of static filter matching which is highly not performance efficient and loaded consumers with additional filtering logic requirement, embodiments of the present disclosure provide a dynamic approach with a filter rule correlated index map which facilitates a transport layer-supported event property insertion to enrich support of subscription rule based query that targets filter specification values. The present disclosure results in a low memory footprint, it requires no filtering implementation requirement on consumers and results in highly improved event traffic efficiency.

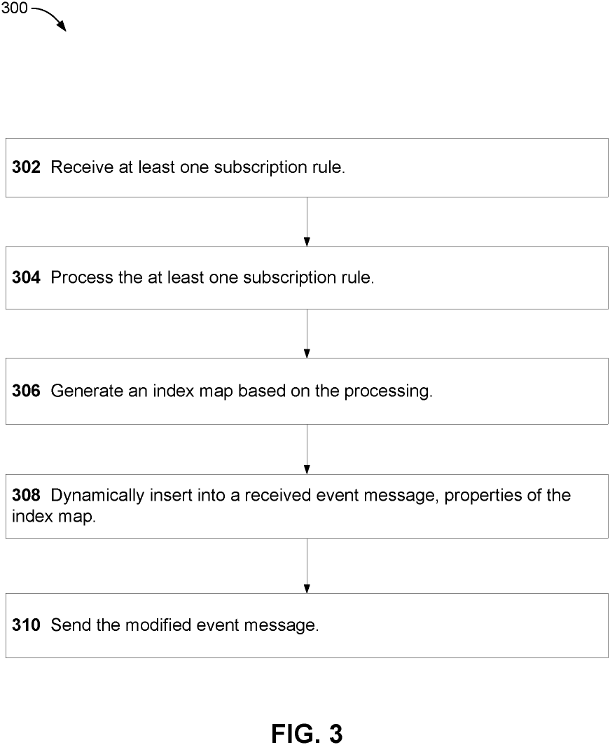

FIG. 3 is flowchart of an example method 300 for an index map-based event system. The method 300 involves, at step 302, receiving, by an event system, at least one subscription rule. The at least one subscription rule may originate from, for example, a user input interface system operated by a user or customer of the event system. In some embodiments the at least one subscription rule includes at least one filter rule. Filter rules may include, for example, source-type targeted filtering rules. Other examples will be discussed below. The method 300 further involves, at step 304, processing, by the event system, the at least one subscription rule. Processing may be achieved by inspecting properties or attributes values of the subscription rule. The method 300 further involves, at step 306, generating, by the event system, an index map based on the processing. Index map generation refers to the method of generating an index map with indices or values that are based on the subscription rule processing results. Thus, the output of step 304 is used as the input of step 306 for the generation of the index map as an output or end result of step 306. The method 300 further involves, at step 308, dynamically inserting, by the event system, into a received event, properties of the index map. The event message may be received by the event system during runtime of such system. The event message can be received from an event producer that is configured to publish events to the system, for example using publish interfaces provided by the event system. As used herein, dynamic refers to the on-demand nature of the property insertion operation applied to events received by the event system. Properties of the index map include key and value attributes in the index map model. Dynamic insertion will be further discussed below, according to embodiments. The method 300 further involves, at step 310, sending, by the event system, the modified event to a transport layer for dispatching. The transport layer in this context is used as a network layer of the event system for event delivery between event producer and consumers. In some embodiments the transport layer is an event middleware that provides the functionality of event orchestration and delivery.

In some embodiments the method further includes querying, by the event system, the transport layer for event subscriptions based on subscription rules to serve targets. Event subscriptions may be subscriptions to a triggering event, for example as specified by a system specification. Targets may be event destination owners or customers. In some embodiments the method further includes dispatching, by a dispatch service, the annotated event of step 308 to targets based on a result of the query. The dispatch service may be a sub-system of the event system.

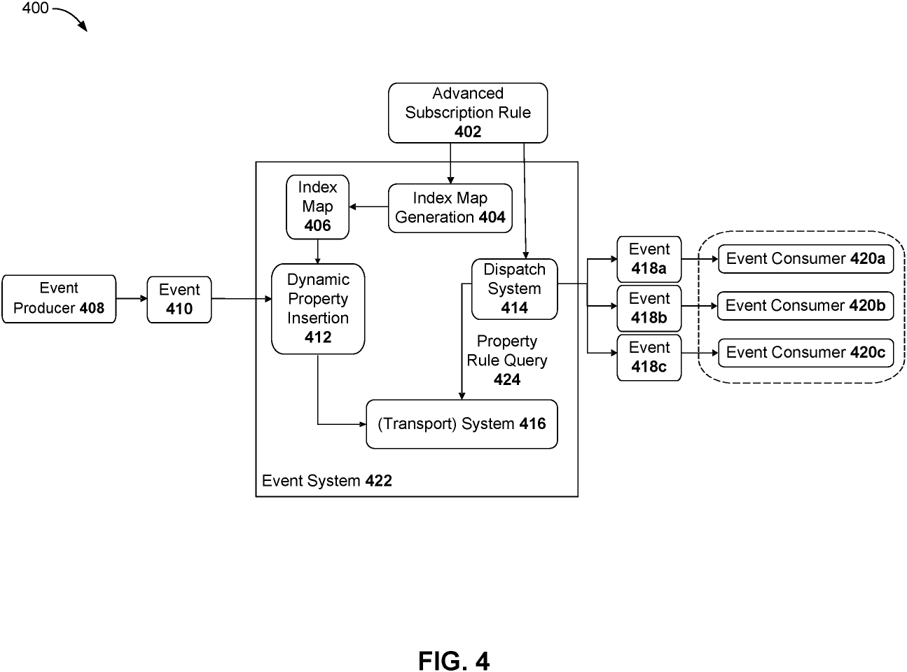

FIG. 4 depicts a schematic 400 based on the index map generation method of FIG. 3. In the schematic 400, an event system 422 receives a subscription rule 402 by system end users (now shown). The event system 422 processed the subscription rule 402, among other subscription rules, for an index map generation 404 (or regeneration). Index map regeneration may be, for example, a dynamic update of the index map. In some embodiments the generated index map 406 contains source event correlated properties (e.g., properties correlated with event properties and subscription rules) to factor in transport layer dispatch (using, for example, dispatch system 414) and query processes (such as property rule query 424). In some embodiments, a source system incoming event 410 (provided by an event producer 408) is annotated with property values (i.e., event property attribute values), at dynamic property insertion (DPI) 412, determined by referencing the index map 406 entry correlated to the same source type identifier of the received event. An index map entry that has a correlation with the event type received will be applied in event updating/annotation. The event 410 is thus annotated and submitted to a transport (broker) system layer 416 for event transit. A transport broker referred to herein may be a generic middleware software, application or service used to transmit events between and producers and consumers in a publish-subscribe pattern. The event system 422 queries the transport broker 416 for event subscription based on subscription rules to serve target consumers, such as event consumers 420a, 420b and 420c. The transport broker provides functionality for querying of events published into the broker entity. The dispatch system 414 further processes and pushes the events (shown as events 418a, 418b and 418c) to event consumers.

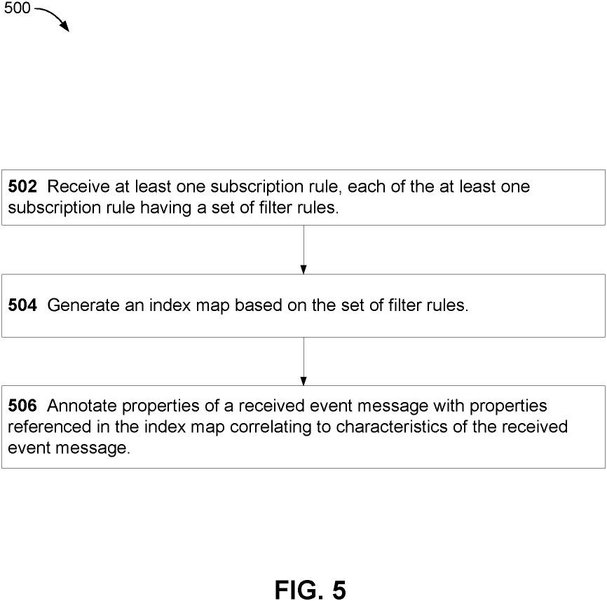

FIG. 5 is flowchart of an example method 500 for dynamic property insertion in an event system. The method 500 involves, at step 502, receiving, by the event system, at least one subscription rule, each of the at least one subscription rule having a set of filter rules. The method 500 further involves, at step 504, generating, by the event system, an index map based on the filter rules. The method 500 further involves, at step 506, annotating, by the event system, properties of a received event with properties referenced the index map correlating to characteristics of the received event. In some embodiments, annotation may occur by programmatically updating the event model with certain properties. Properties of a received event may include attributes, key and values of an event, while characteristics may be properties of correlation between the rules input and event properties.

In some embodiments the characteristics include at least one of: an event generation system, an event generation application; and event generation service; an event consumption system; an event consumption application; and an event consumption service. In some embodiments the method further includes sending, by the event system, the annotated event to a transport layer for dispatching. In some embodiments the method further includes querying, by the event system, the transport layer by event target subscription for subscription delivery.

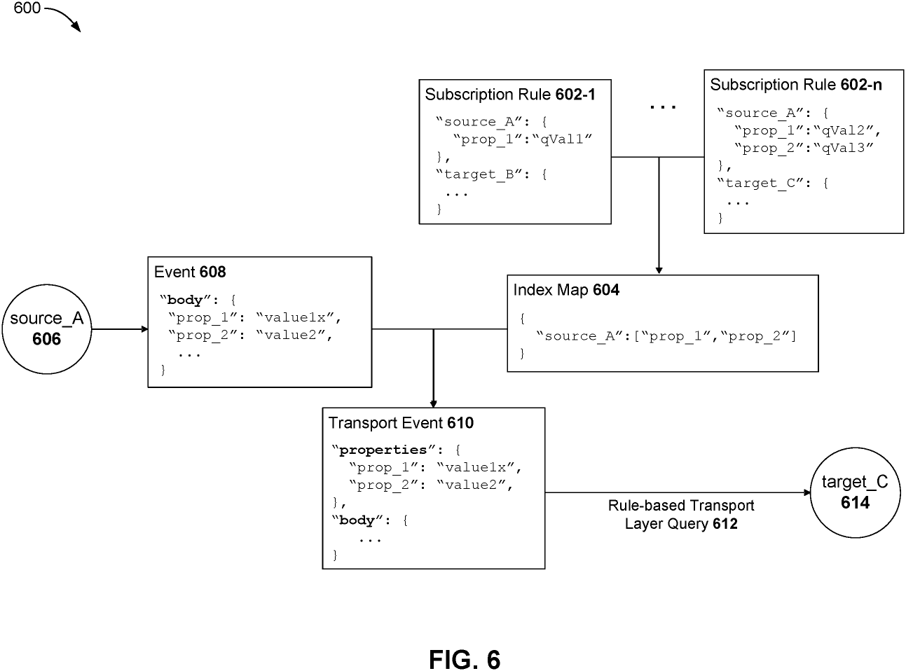

FIG. 6 depicts a schematic of an event system 600 based on the dynamic property insertion method of FIG. 4. In the event system 600, subscription rules 602-1 to 602-n are submitted via an event system Application Programming Interface (API) endpoint (not shown). Filter rules are applied in the generation of an index map (model) 604, as an index map is a property model by nature. The index map 604 is a dynamic entry based on source-type targeted filtering rules by subscribers. In some embodiments, source-type targeted filtering rules form part of the subscription rules 602. The index map 604 is updated systematically (e.g., based on any change of subscription rules 602 provided by users of the event system 600) upon changes of filter rules. When an event 608 is submitted by a source A 606 to the event system 600 via an API endpoint, the event 608 is annotated with properties referenced in the index map 604 entry that is correlated with the event source system, application or service. Property annotation is sensitive to the dynamic natured index map 604, and is not limited by a source-defined static topic correlation at event arrival. This results in a much lighter, yet more flexible event annotation to facilitate any type of subscription rule query. The event 608 with dynamic property annotation is redefined as a transport event 610. Then, with rule-based transport layer query 612, the transport event 610 target subscription is submitted to the transport layer for subscription delivery processing and eventual transmission to a target_C 614.

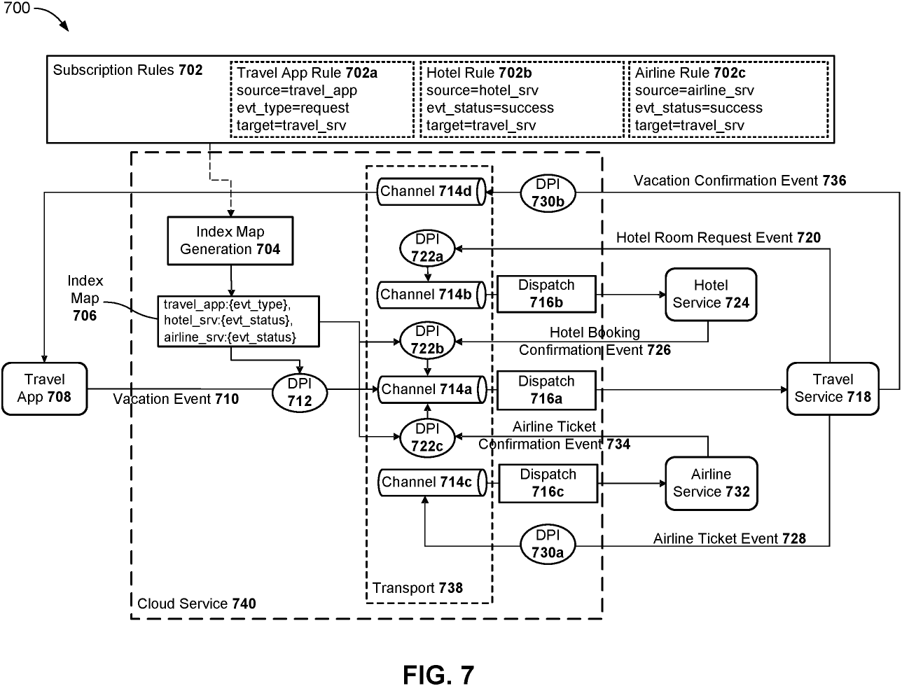

FIG. 7 depicts an example event system 700 for dynamic index map generation and index map based property annotation in transport query for an EDA. The query may be applied against a transport layer/middleware for events retrieval. For example purposes only, the system 700 describes a travel or vacation booking system, in which subscription rules 702 (which may include a travel application rule 702a, a hotel rule 702b and an airline rule 702c) are used for index map generation 704, to generate (or regenerate) an index map 706. In some embodiments the at least one subscription rule 702 includes at least one filter rule. In some embodiments the index map 706 contains event correlated properties including at least one of: transport layer dispatch properties; and query process properties. Transport layer dispatch properties and query process properties are properties factored by the transport layer in dispatch and query operations. Then, when a user or consumer using a travel application 708 creates a vacation event 710, properties of the index map 706 are dynamically inserted into the vacation event 706 at dynamic property insertion (DPI) 712, before the event is sent to channel 714a. In some embodiments which properties of the index map 706 are to be dynamically inserted into the received event message is determined by comparing the index map 706 with a source type identifier of the received event message, wherein the attribute values compare operations. In some embodiments characteristics of the received event message used for comparison include at least one of: an event consumption system; an event consumption application; and an event consumption service. From channel 714a, a dispatch 716a sends the event to a travel service 718. The travel service 718 is able to create further events, such as the hotel room request event 720, the airline ticket event 728 and the vacation confirmation event 736. The hotel room request event 720 is sent to DPI 722a for insertion of properties which may be in relation to certain requirements from the travel service 718. The event 720 is then sent to channel 714b, before being sent to a dispatch 716b for dispatching to hotel service 724. If the hotel service 724 is able to fulfil the request, it sends a hotel booking confirmation event 726 to channel 714a, after insertion of any properties specific to the hotel booking at DPI 722b. The event 726 is then sent to dispatch 716a to be dispatched back to the travel service 718. Dispatch 716a honours subscription rules 702 in its dispatching decision. Similarly, the airline ticket event 728 is sent by the travel service 718 to channel 714c, after having properties specific to the travel service 718a inserted at DPI 730a. Next, the event 728 is sent to dispatch 716c for dispatching to the airline service 732. If the airline service 732 is able to fulfil the request, it sends an airline ticket confirmation event 734 to channel 714a, after properties specific to the airline service 732 are added at DPI 722c. The event 734 is then sent to dispatch 716a to be dispatched back to the travel service 718. With the hotel and airline aspects confirmed, the travel service 718 sends a vacation confirmation event 736 to channel 714d, after insertion of any properties at DPI 730b. The confirmation event 736 is then sent back to the travel application 708 for the consumer.

Channel 714d, DPI 722a, channel 714b, DPI 722b, channel 714a, DPI 722c and channel 714c are depicted as being within a transport layer 738. The elements operating within the transport layer 738, together with the remaining instances of dynamic property insertion (DPI), dispatching and generation (or regeneration) of index maps, are depicted as operating within the cloud service 740.

Similar to FIG. 2, where services may be unable to fulfil a request, a corresponding event may still be sent in order to indicate that. This could take the form of a “denial event” instead of a “confirmation event”. Such a “denial event” may, for example, be dispatched by dispatch 716a to a different handler service (not shown) based on different subscription rules that route the event with a filter based on different property values. Such events may still be used in the system 700 to provide an overall confirmation or denial of the relevant service.

In some embodiments the system 700 further comprises querying, by the event system 700, a transport layer 738 for event subscriptions based on subscription rules 702 to serve targets. In some embodiments the system 700 further comprises dispatching, by a dispatch service (716), the annotated event message to targets based on a result of the query. In some embodiments the system 700 further comprises sending, by the event system 700, the annotated event message to a transport layer 738 for dispatching. In some embodiments the system 700 further comprises querying, by the event system 700, the transport layer 738 by event target subscription for subscription delivery.

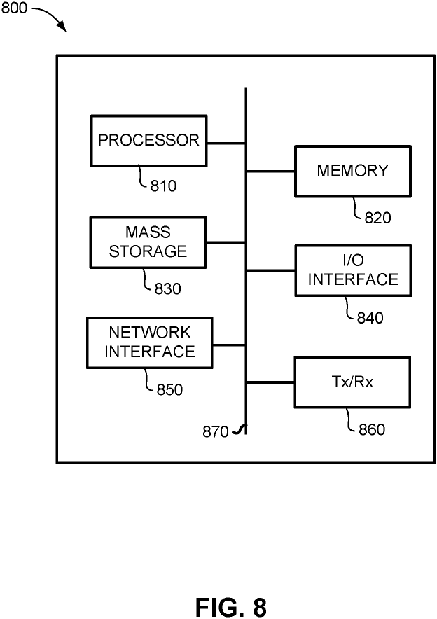

FIG. 8 is a schematic diagram of an electronic device 800 that may perform any or all of the steps of the above methods and features described herein, according to different embodiments of the present disclosure. As shown, the device includes a processor 810, memory 820, non-transitory mass storage 830, I/O interface 840, network interface 850, and a transceiver 860, all of which are communicatively coupled via bi-directional bus 870. According to certain embodiments, any or all of the depicted elements may be utilized, or only a subset of the elements. Further, the device 800 may contain multiple instances of certain elements, such as multiple processors, memories, or transceivers. Also, elements of the hardware device may be directly coupled to other elements without the bi-directional bus.

The memory 820 may include any type of non-transitory or non-transient memory such as static random access memory (SRAM), dynamic random access memory (DRAM), synchronous DRAM (SDRAM), read-only memory (ROM), any combination of such, or the like. The mass storage element 830 may include any type of non-transitory storage device, such as a solid state drive, hard disk drive, a magnetic disk drive, an optical disk drive, USB drive, or any computer program product configured to store data and machine executable program code. According to certain embodiments, the memory 820 or mass storage 830 may have recorded thereon statements and instructions executable by the processor 810 for performing any of the aforementioned method steps described above.

The example embodiments described above may be implemented by using hardware only or by using software and a necessary universal hardware platform. Based on such understandings, the technical solution of some example embodiments may be embodied in the form of a software product. The software product may be stored in a non-volatile or non-transitory storage medium, which can be a compact disk read-only memory (CD-ROM), Universal Serial Bus (USB) flash disk, or a removable hard disk. The software product includes a number of instructions that enable a computer device (personal computer, server, or network device) to execute the methods provided in the example embodiments. The software product may additionally include a number of instructions that enable a computer device to execute operations for configuring or programming a digital logic apparatus in accordance with example embodiments.

Example systems and methods described herein, in accordance with example embodiments, can be implemented by one or more controllers. The controllers can comprise hardware, software, or a combination of hardware and software, depending on the particular application, component or function. In some example embodiments, the one or more controllers can include analog or digital components, and can include one or more processors, one or more non-transitory storage mediums such as memory storing instructions executable by the one or more processors, one or more transceivers (or separate transmitters and receivers), one or more signal processors (analog or digital), and one or more analog circuit components.

It will be appreciated that, although specific embodiments of the technology have been described herein for purposes of illustration, various modifications may be made without departing from the scope of the technology. The specification and drawings are, accordingly, to be regarded simply as an illustration of the disclosure as defined by the appended claims, and are contemplated to cover any and all modifications, variations, combinations or equivalents that fall within the scope of the present disclosure. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the methods described herein can be implemented as coded instructions in a computer program product. In other words, the computer program product is a computer-readable medium upon which software code is recorded to execute the methods when the computer program product is loaded into memory and executed on the microprocessor of the wireless communication device.

Acts associated with the methods described herein can be implemented as coded instructions in plural computer program products. For example, a first portion of the method may be performed using one computing device, and a second portion of the method may be performed using another computing device, server, or the like. In this case, each computer program product is a computer-readable medium upon which software code is recorded to execute appropriate portions of the method when a computer program product is loaded into memory and executed on the microprocessor of a computing device.

Further, each step of the methods may be executed on any computing device, such as a personal computer, server, PDA, or the like and pursuant to one or more, or a part of one or more, program elements, modules or objects generated from any programming language, such as C++, Java, or the like. In addition, each step, or a file or object or the like implementing each said step, may be executed by special purpose hardware or a circuit module designed for that purpose.

Although the present disclosure has been described with reference to specific features and embodiments thereof, it is evident that various modifications and combinations can be made thereto without departing from the disclosure. The specification and drawings are, accordingly, to be regarded simply as an illustration of the disclosure as defined by the appended claims, and are contemplated to cover any and all modifications, variations, combinations or equivalents that fall within the scope of the present disclosure.

1. A method comprising, by an event system:
receivingat least one subscription rule from a user input interface system;
processingthe at least one subscription rule, the processing including inspecting a property or an attribute value of the at least one subscription rule;
generatingan index map based on the processing;
dynamically insertinginto an event message received from an event producer, in response to receiving the event message, properties of the index map to make a modified event message; and
sendingthe modified event message.

2. The method of claim 1 wherein the index map contains event correlated properties including at least one of:
transport layer dispatch properties; and
query process properties.

3. The method of claim 1 wherein which properties of the index map are to be dynamically inserted into the received event message is determined by comparing the index map with a source type identifier of the received event message.

4. The method of claim 1 wherein the sending comprising sending the modified event message to a transport layer for dispatching.

5. The method of claim 1 further comprising querying, by the system, a transport layer for event subscriptions based on subscription rules.

6. The method of claim 5 further comprising dispatching, by a dispatch service, the modified event message based on a result of the querying.

7. The method of claim 1 wherein the at least one subscription rule includes at least one filter rule, the index map being generated based on the at least one filter rule.

8. A method comprising:
receiving, by a system, at least one subscription rule from a user input interface system, each of the at least one subscription rule having a set of filter rules;
generating, by the system, an index map based on the set of filter rules; and
annotating, by the system, properties of a received event message with properties referenced in the index map correlating to characteristics of the received event message, the event message received from an event producer.

9. The method of claim 8 wherein the characteristics include at least one of: an event generation system;
an event generation application;
an event generation service;
an event consumption system;
an event consumption application; or
an event consumption service.

10. The method of claim 8 further comprising sending, by the system, the annotated event message to a transport layer for dispatching.

11. The method of claim 10 further comprising querying, by the system, the transport layer by event target subscription for subscription delivery.

12. A system comprising at least one processor and memory storing instructions for execution by the at least one processor to implement:
receive at least one subscription rule from a user input interface system, the at least one subscription rule having a set of filter rules;
generate an index map based on the set of filter rules;
receive an event message from an event producer; and
annotate properties of the received event message with properties referenced the index map correlating to characteristics of the received event message.

13. The system of claim 12 wherein the index map contains event correlated properties including at least one of:
transport layer dispatch properties; and
query process properties.

14. The system of claim 12 wherein which properties of the index map are to be dynamically inserted into the received event message is determined by comparing the index map with a source type identifier of the received event message.

15. The system of claim 12 wherein the memory further stores instructions for execution by the at least one processor to implement:
query a transport layer for event subscriptions based on subscription rules.

16. The system of claim 15 wherein the memory further stores instructions for execution by the at least one processor to implement:
dispatch the annotated event message based on a result of the querying.

17. The system of claim 12 wherein the at least one subscription rule includes at least one filter rule.

18. The system of claim 12 wherein the characteristics include at least one of: an event generation system;
an event generation application;
an event generation service;
an event consumption system;
an event consumption application; or
an event consumption service.

19. The system of claim 12 wherein the memory further stores instructions for execution by the at least one processor to implement: send the annotated event message to a transport layer for dispatching.

20. The system of claim 19 wherein the memory further stores instructions for execution by the at least one processor to implement: query, the transport layer by event target subscription for subscription delivery.
